(19) United States
(12) Patent Application Publication
(10) Pub. No.: US 2015/0093308 A1
(43) Pub. Date: Apr. 2, 2015

(54) Device for Supporting Reaction Vessels in a Microwave Heating Apparatus

(71) Applicant: Anton Paar GmbH, Graz (AT)

(72) Inventors: Rainer Zentner, Graz (AT); Heimo Kotzian, Graz (AT); Johannes Zach, St. Marein bei Graz (AT); Josef Schnur, Graz (AT); Elisabeth Gangl, Graz (AT)

(73) Assignee: Anton Paar GmbH, Graz (AT)

(21) Appl. No.: 14/040,204

(22) Filed: Sep. 27, 2013

(51) Int. Cl. B01J 19/28; B01J 19/12

(52) U.S. Cl. CPC B01J 19/28; B01J 19/126; B01J 2219/1257
USPC 422/566; 422/198

(57) ABSTRACT

There is described a device for rotatably supporting at least one reaction vessel in a microwave heating apparatus. The described device comprises (a) a base plate comprising at least one through-hole, and (b) at least one tubular member having a longitudinal axis and being adapted to receive a reaction vessel and to be coupled to the base plate in such a way that the longitudinal axis of the at least one tubular member passes through the at least one through-hole, wherein the at least one tubular member comprises metal. Furthermore, there is described a system for performing digestion or synthesis comprising a microwave heating apparatus and a device as described above.

### TECHNICAL FIELD

The present invention relates to the field of microwave-assisted chemistry, such as digestion and synthesis, and in particular to the field of structures for supporting reaction vessels in a microwave heating apparatus.

### BACKGROUND

In microwave-assisted chemistry, microwave energy is used to increase temperature in chemical synthesis, chemical analysis and similar processes. Thereby, known chemical reactions and processes can be accelerated, the yield can be increased, and the purity of the products can be improved. However, the large amount of energy, which is applied to the samples in microwave-assisted chemistry, also enables completely new syntheses and reactions.

Many devices and methods for microwave-assisted chemistry are based on the concept of household microwave ovens adapted for such use and operate at frequencies around 915 MHz or 2.45 GHz. The large pressure and temperature that may occur in the reaction vessels during sample heating in a multi mode device require the use of expensive materials for the interior structure of the heating devices which can resist the impact of a sample leaking from a broken vessel. Installation of temperature and pressure sensors is a complicated task due to the need for protecting such sensors against microwave radiation. Furthermore, care has to be taken as regards material and geometry of the sensor components in order to assure that these do not heat up and/or cause sparks when subjected to microwave radiation.

Standing waves of different longitudinal and transversal modes of the microwave field are super-positioned within the cavity of such ovens. Therefore, the spatial energy distribution is non-homogeneous and exhibits so-called “hot spots” and “cold spots”. Examples of such classical multi mode microwave heating systems are e.g. Anton Paar “Multiwave 3000”.

Microwave transparent reaction vessels are arranged in microwave transparent vessel carriers and positioned within the microwave oven which is flushed with microwaves. Due to the non-uniform energy distribution, it is customary to place the reaction vessels on a rotatable support structure, such as a turn table. By rotating the support structure during heating, the level of applied energy to the samples may be evened out. It is furthermore known to implement mechanisms for stirring the samples and to change the superpositioned modes within the cavity, i.e. so-called modemixing. Various techniques are preferably or necessarily carried out in sealed vessels which must be able to withstand high pressures. Processes are carried out with the help of acids, oxidizing agents or aggressive chemical substances.

Accordingly, different reaction vessels are designed to withstand the pressure and temperature occurring during sample heating as well as the resistance to the chemicals of the reaction.

DE 44 13 425 A1 shows a rotatable vessel support device made from a microwave transparent material. The microwave transparent reaction vessels with respective samples are arranged in the device and the whole arrangement is positioned within the multi mode chamber of a microwave heating device or oven, such that microwave-assisted chemistry can be performed. Such vessel support devices are usually, as described e.g. in DE 93 09 355 U1, made from microwave transparent material. The reaction vessels are thermally decoupled from the microwave transparent vessel carriers.

Microwave transparent materials offering these structural capabilities and chemical stability such as quartz, high strength polymers or ceramics tend to be brittle. Another drawback is the poor thermal conductivity of bulky thick-walled vessels. Cooling of the reaction solution after finishing the heating process will take long time, even when concurrent cooling of the vessels is used.

The use of synthetic and composite materials with e.g. glass fibers leads, however, to several disadvantages and drawbacks. When structurally stable high-performance synthetic materials are brought close to their thermal limits of use, they exhibit relatively low strength and get worn out relatively fast. Wound glass tubes comprising a synthetic matrix are relaxed in the cross-section due to strain and become frayed at the front surfaces. Glass and ceramics are brittle, sensitive and expensive. Furthermore, all these materials exhibit microwave absorption to some extent and may thus cause a loss of microwave energy in the pressure shell. Therefore, reaction vessels are used in connection with multilayer vessel supports as such vessels also have the necessary structure stability at high temperatures and can provide sufficient supporting function for the liner used (the inner sample vessel is in most cases separately made from PTFE and is inserted into the support structure or sleeve). A particular support sleeve for such vessels, which is made from microwave transparent material, is shown in U.S. Pat. No. 6,926,939.

Support sleeve and rotatable support structure can be a joint assembly to receive the inner sample vessel or liner. Various caps and or lids are known to seal these vessels and to measure pressure and or temperature within the vessel.

There may be a need for a simple, improved and non-expensive way of supporting reaction vessels in microwave-assisted chemistry.

### SUMMARY

This need may be met by the subject-matter according to the independent claims. Advantageous embodiments of the present invention are set forth in the dependent claims.

According to a first aspect there is provided a device for rotatably supporting at least one reaction vessel in a microwave heating apparatus. The described device comprises (a) a base plate comprising at least one through-hole, and (b) at least one tubular member having a longitudinal axis and being adapted to receive a reaction vessel and to be coupled to the base plate in such a way that the longitudinal axis of the at least one tubular member passes through the at least one through-hole, wherein the at least one tubular member comprises metal.

This aspect is based on the idea that a metallic tubular member is used to provide the functions of support and pressure protection, which is inserted into the tubular member.

In the present context, the term “base plate” may particularly denote a substantially flat structure having a significantly larger width than thickness. The base plate preferably comprises two opposing main sides, such as an upper flat surface and a lower flat surface, and an edge extending circumferentially along an outer periphery of the base plate. The base plate may preferably have a substantially circular cross-sectional shape in which case the base plate is disc-shaped. However, other cross-sectional shapes, such as substantially triangular, quadratic or elliptical, may also be used.

In the present context, the term “tubular member” may particularly denote an elongate cylindrical member, such as a section of a tube. The tubular member may preferably have a circular cross-section such that an inserted reaction vessel may fit snuggly within the tubular member.

The tubular member is coupled to the base plate such that the longitudinal axis of the tubular member is substantially perpendicular to the plane of the base plate and such that at least a part of the opening of the tubular member overlaps at least a part of the through-hole of the base plate. Thereby, when a reaction vessel is positioned in the tubular member, an end portion of such reaction vessel may extend into or even through the through-hole of the base plate. This is particularly beneficial if the microwave field is significantly attenuated within the tubular member. In this case, the part of the end portion of the reaction vessel extending through the base plate may, due to the dielectric properties of the reaction vessel and the sample contained therein, act as a microwave antenna such that microwave radiation can propagate into the reaction vessel.

The metallic tubular member may act as an outer reinforcement of the reaction vessel, which reduces the risk that the reaction vessel bursts due to high pressure during heating of a sample contained within the vessel.

The metal may preferably be chosen so as to exhibit excellent thermal conduction properties. Thereby, cooling of a sample in a reaction vessel such as a liner may be enhanced. Thereby, the risk of a vessel bursting or leaking due to extreme heat in a limited area of the vessel can also be reduced.

Accordingly, the described device may obviate the need for complicated multi-layer pressure reaction vessels and thereby provide a significant cost reduction.

According to an embodiment, the device further comprises a support element arranged at one side of the base plate and comprising a microwave transparent material.

The support element may preferably be configured to support an end portion of a reaction vessel residing in the tubular member such that the reaction vessel is held in a desired position relative to the tubular member. This may for example be achieved by providing the support element with an opening having a somewhat smaller diameter than the inner diameter of the tubular member, such that only a tip of the end portion may fit into the opening in the support element. As another example, the support element may comprise a cut-out portion or a recess shaped to receive and support the end portion of the reaction vessel.

The support element may preferably be arranged on a main surface of the base plate such that the support element covers a part of or the entire main surface. In particular, the support element may be formed as a layer on the base plate. Alternatively, the support element may be formed integrally with the base plate such that it in fact constitutes the base plate. In the latter case, the tubular member may be screwed into the through-hole in the base plate (support element).

Thereby, when the base plate is arranged within a microwave heating apparatus such that the base plate is substantially parallel with a bottom of the microwave heating apparatus, the lower end portion of the reaction vessel may be surrounded by or even extend partially through the microwave transparent material of the support element. Accordingly, even if the microwave radiation is strongly attenuated within the tubular member, at least the lower end portion of the reaction vessel may catch microwave radiation and guide it into the rest of the reaction vessel when the vessel contains a dielectric sample.

According to a further embodiment, the at least one tubular member is arranged on the side of the base plate opposite to the side at which the support element is arranged.

In this embodiment, the reaction vessel residing within the tubular member extends through the through-hole in the base plate such that the end portion of the reaction vessel is supported by the support element.

According to a further embodiment, the base plate and the at least one tubular member are integrally formed.

In this embodiment, the base plate also comprises metal and the tubular member is coupled to the base plate e.g. by welding or soldering. Here, it is important to provide electrical contact between the tubular member and the base plate in order to reduce the risk of sparks when the device is exposed to microwave radiation.

According to a further embodiment, the metal comprises aluminum, stainless steel and/or a nickel-based alloy.

Examples of useful nickel-based alloys are e.g. the range of nickel-chromium based alloys known as Inconel which further to the main components (Ni and Cr) may comprise one or more of the following elements: Mb, Fe, Nb, Co, Mn, Cu, Al, Ti, Si, C, S, P, B.

The above mentioned metals and alloys have excellent resistance to elevated temperatures, oxidation and corrosion. Furthermore, they are stable, strong, ductile, and relatively inexpensive in comparison to complex synthetic and composite materials.

According to a further embodiment, the base plate and/or the at least one tubular member comprise an anticorrosive coating.

The anticorrosive coating may preferably be a Teflon® coating (or similar fluoropolymers) which protects the base plate and/or tubular member against corrosion as well as the impacts of heated sample material leaking from the reaction vessel. Teflon is a registered trademark of E.I. Du Pont De Nemours and Company of Wilmington, Del., U.S.A.

According to a further embodiment, the at least one tubular member is adapted to attenuate microwave propagation within the tubular member.

This may e.g. be achieved by selecting the diameter of the tubular member relative to the frequency of the microwave radiation which is utilized by the microwave heating apparatus.

It is noted that in the present context, “attenuate microwave propagation within the tubular member” refers to the situation where no dielectric sample substance is present (in a reaction vessel) within the tubular member.

According to a further embodiment, the at least one through-hole is a plurality of through-holes, the at least one tubular member is a plurality of tubular members, and the longitudinal axis of each tubular member passes through one of the plurality of through-holes.

In other words: The base plate comprises a plurality of through-holes, and each of a plurality of tubular members is coupled to the base plate in such a way that at least a part of the opening of each tubular member overlaps at least a part of a corresponding through-hole in the base plate.

The features of the first aspect and the above mentioned embodiments apply equally to the plurality of tubular members and through holes of this embodiment.

Accordingly, the present embodiment is capable of supporting a plurality of reaction vessels. Furthermore, in the case of a metallic base plate, the present embodiment may even provide balancing or equalizing of sample temperature among different vessels.

According to a further embodiment, the plurality of through-holes comprises a first group of through-holes which are positioned in the vicinity of a periphery of the base plate.

The first group of through holes may comprise one through hole, two or more through holes or even all the through holes of the plurality of through holes.

The first group of through holes may preferably be arranged with constant spacing or pitch on a circle.

According to a further embodiment, the plurality of through-holes comprises a second group of through-holes which are positioned at a predetermined distance between a centre of the base plate and the periphery of the base plate.

The second group of through holes may preferably be arranged with constant spacing or pitch on a circle having a smaller diameter than the circle on which the first group of through holes is arranged.

Thereby, the use of the surface area of the base plate can be maximized such that the use of space within the microwave heating apparatus is optimized.

According to a second aspect there is provided a system for performing digestion or synthesis of at least one sample provided in a reaction vessel. The described system comprises (a) a microwave heating apparatus, and (b) a device according to the first aspect or any of the above described embodiments thereof.

Also this aspect is based on the idea that a metallic tubular member is used to provide the functions of support, pressure protection, and thermal coupling for a reaction vessel which is inserted into the tubular member.

The microwave heating apparatus may preferably be a standard household microwave oven or a microwave heating apparatus specially designed for use in microwave-assisted chemistry.

The aspects defined above and further aspects of the present invention are apparent from the examples of embodiment to be described hereinafter and are explained with reference to the examples of embodiment. The invention will be described in more detail hereinafter with reference to examples of embodiment to which the invention is, however, not limited.

### BRIEF DESCRIPTION OF THE DRAWING

FIG. 1 shows a schematic view of an embodiment situated in a multi mode microwave heating system.

### DETAILED DESCRIPTION

The illustration in the drawing is schematic. It is noted that in different FIGURE, similar or identical elements are provided with the same reference signs or with reference signs, which differ only within the first digit.

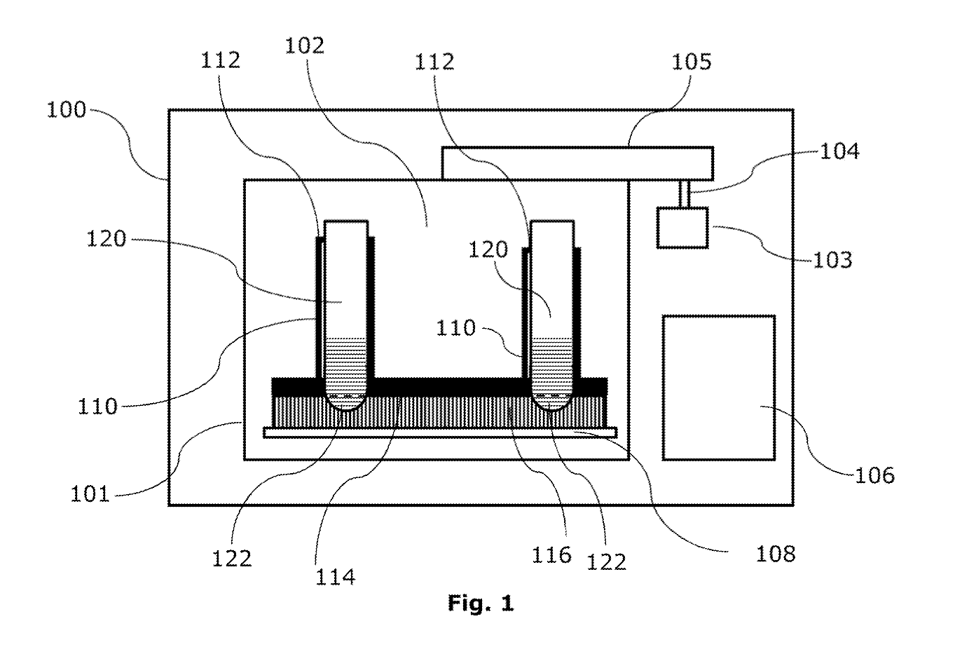

FIG. 1 shows a schematic view of a device according to an embodiment, which device is arranged in a microwave heating apparatus 100.

The microwave heating apparatus 100 is preferably a multimode microwave oven and comprises an inner wall 101 which bounds the microwave cavity 102. The microwave heating apparatus further comprises means for generating microwaves, for example a magnetron 103, and means for feeding microwave to the microwave cavity 102, for example antenna 104 and waveguide 105, an operation panel 106 for controlling operation of the apparatus, and a turntable 108. The turntable 108 is constituted by a disc-shaped element which is rotatably arranged and connected to a drive mechanism (not shown) for rotating the turntable 108 during operation of the apparatus 100.

The device comprises tubular members 110 having openings 112 at their respective tops for receiving reaction vessels 120. The tubular members 110 are made of metal, such as aluminum, stainless steel or a nickel-based alloy (e.g. Inconel®). Inconel is a registered trademark of the International Nickle Company, Inc. of New York, N.Y., U.S.A. The tubular members 110 have a substantially circular cross-section and are arranged on a base plate 114 such that the longitudinal axis of the tubular members 110 is perpendicular to the base plate 114. The base plate 114 is a substantially circular disc made of a synthetic and/or composite material and may be an integral part of the turntable 108, such as e.g., Fluoropolymers, modified thermosetting polyester, glass.

In this case, the tubular members 110 are screwed into the through-holes in the base plate 114.

Alternatively, the base plate 114 may be made of metal, such as aluminum, stainless steel or a nickel-based alloy (e.g. Inconel®), or any suitable combination thereof. In this case, the tubular members 110 are coupled to the base plate 114 by welding or soldering such that a good electrical contact is established between the tubular members 110 and the base plate 114.

The base plate 114 comprises through-holes (not shown) at the positions where the tubular members 110 are arranged. The through-holes are aligned with the tubular members 110 such that reaction vessels 120 inserted into the tubular members may extend at least partially through the openings. The diameter of the tubular members 110 is selected such that the reaction vessels fit snugly within the tubular members 110. Although FIG. 1 only shows two tubular members 110, it should be noted that the device is rotationally symmetric in the sense that tubular members 110 are arranged with a given pitch along a circle in the vicinity of the circumference of the base plate 114. More specifically, the device may e.g. comprise 8, 16, 24 or 32 tubular members along the circle in the vicinity of the periphery. Furthermore, tubular members may also be arranged along one or more further pitched circles extending closer to the center of the base plate. In other words, the further pitched circles have gradually smaller diameters than the outer pitched circle.

The tubular members 110 are arranged at an upper side of the base plate 114. On the opposite side, i.e. a lower side, of the base plate there is arranged a support element 116. The support element 116 is a substantially disc-shaped element having about the same diameter as the base plate 114. The support element 116 comprises a microwave transparent material, such as ceramics, glass, composite materials, Polymer materials like PEEK, PTFE, and cavities or recesses designed to receive lower portions 122 of the reaction vessels 120. Furthermore, the support element 116 has a substantially flat lower surface for assuring stability when the device is arranged on the turntable 108 within the cavity 102 of the microwave heating device 100.

During operation of the microwave heating apparatus, the turntable 108 and the device arranged thereon rotate such that the tubular members 110 (and the respective inserted reaction vessels 120) are moved through regions of different microwave intensity (cold spots and hot spots). Due to the dielectric properties of the samples in the reaction vessels, microwave radiation is received at least by the part of the sample contained in the lower portions 122 of the reaction vessels 120 and propagated into the remaining part of the samples which are surrounded by the metallic tubular members 110. The close fit between the metallic tubular members 110 and the inserted reaction vessels 120 provide reinforcing protection against high pressures within the vessels 120 and further provide a distribution of thermal energy within the sample such that a homogeneous heating of the samples can be achieved.

It is noted that, unless otherwise indicated, the use of terms such as “upper”, “lower”, “left”, and “right” refers solely to the orientation of the corresponding drawing.

It should be noted that the term “comprising” does not exclude other elements or steps and that the use of the articles “a” or “an” does not exclude a plurality. Also elements described in association with different embodiments may be combined. It should also be noted that reference signs in the claims should not be construed as limiting the scope of the claims.

1. A device for rotatably supporting at least one reaction vessel in a microwave heating apparatus, the device comprising:
a base plate comprising at least one through-hole; and
at least one tubular member having a longitudinal axis and being adapted to receive a reaction vessel and to be coupled to the base plate in such a way that the longitudinal axis of the at least one tubular member passes through the at least one through-hole;
wherein the at least one tubular member comprises metal.

2. The device according to claim 1, further comprising:
a support element arranged at one side of the base plate and comprising a microwave transparent material.

3. The device according to the claim 2, wherein the at least one tubular member is arranged on the side of the base plate opposite to the side at which the support element is arranged.

4. The device according to claim 1, wherein the base plate and the at least one tubular member are integrally formed.

5. The device according to claim 1, wherein the metal comprises aluminum, stainless steel and/or a nickel-based alloy.

6. The device according to claim 1, wherein the base plate and/or the at least one tubular member comprise an anticorrosive coating.

7. The device according to claim 1, wherein the at least one tubular member is adapted to attenuate microwave propagation within the tubular member.

8. The device according to claim 1, wherein the at least one through-hole is a plurality of through-holes, the at least one tubular member is a plurality of tubular members, and the longitudinal axis of each tubular member passes through one of the plurality of through-holes.

9. The device according to claim 8, wherein the plurality of through-holes comprises a first group of through-holes which are positioned in the vicinity of a periphery of the base plate.

10. The device according to claim 8, wherein the plurality of through-holes comprises a second group of through-holes which are positioned at a predetermined distance between a centre of the base plate and the periphery of the base plate.

11. A system for performing digestion or synthesis of at least one sample provided in a reaction vessel, the system comprising:
a microwave heating apparatus; and
a device according to claim 1.
